(19) United States
(12) Patent Application Publication
(10) Pub. No.: US 2025/0180126 A1
(43) Pub. Date: Jun. 5, 2025

(54) Flow Control Assembly for a Valve

(71) Applicant: Fisher Controls International LLC, Marshalltown, IA (US)

(72) Inventor: Rusty Rhamy, Marshalltown, IA (US)

(21) Appl. No.: 18/528,398

(22) Filed: Dec. 4, 2023

(51) Int. Cl. F16K 5/08; F16K 1/46

(52) U.S. Cl. CPC F16K 5/08; F16K 1/46

(57) ABSTRACT

A plug assembly for a valve can include a valve cage, an outer plug, an inner plug, and respective outer and inner seat rings. The outer seat ring can be fixed relative to the cage and the inner seat ring can be fixed relative to the outer plug. The inner plug can be disposed within a flow cavity formed in the outer plug and fixed to a valve stem of the valve. In use, during a relatively low range of flow rates, the outer plug can remain seated on the outer seat ring and the inner plug can move axially away from the inner seat ring and within the flow cavity to provide a low flow rate control. During a relatively high range of flow rates, each of the inner and outer plugs can lift off their respective seat rings to provide a higher flow rate control.

### CROSS-REFERENCE TO RELATED APPLICATIONS

Not applicable.

### BACKGROUND

Flow control devices can be used in a variety of industrial, commercial, and other settings including to regulate flow rate or pressure of a fluid flowing from a fluid source. In some applications, it may be useful to manage the flow rate or pressure or other characteristics of a fluid flowing from the pressure source toward a downstream application or device.

### SUMMARY

Some examples of the present disclosure provide a plug assembly for a valve. The valve can include a valve inlet and a valve outlet. The plug assembly can include a cage, an outer seat ring, an inner seat ring, an outer plug, and an inner plug. The outer seat ring can be fixed to, or relative to, the cage. The outer plug can be in fluid communication with the valve inlet. The outer plug can be configured to move in an axial direction relative to the cage and to sealingly engage the outer seat ring. The inner seat ring can be fixed to, or relative to, the outer plug. The inner plug can be in fluid communication with the valve inlet. The inner plug can be configured to move in the axial direction relative to the outer plug and the outer seat ring. The inner plug can sealingly engage the inner seat ring. To control flow over a first range of flow rates, the inner plug can be disengaged from the inner seat ring and the outer plug can be sealingly engaged with the outer seat ring. To control flow over a second range of flow rates, the inner plug can be disengaged from the inner seat ring and the outer plug can be disengaged from the outer seat ring.

In some examples, the present disclosure can provide a flow control assembly for a valve. The valve can include a valve body and have a valve stem. The valve body can define a valve inlet and a valve outlet. The flow control assembly can include first and second valve seats and first and second flow control members. The first flow control member can define a flow cavity. The first flow control member can be moveable relative to the first valve seat in an axial direction and can be configured to sealingly engage the first valve seat. The second valve seat can be fixed relative to the first flow control member. The second flow control member can be disposed within the flow cavity of the first flow control member and to the valve stem. The second flow control member can be movable in the axial direction relative to the valve body and the first flow control member. The second flow control member can be configured to sealingly engage the second valve seat.

In some examples, the present disclosure can provide a method of assembling a plug assembly for a valve. The valve can include a valve stem. The method can include fixing an inner plug of the plug assembly to the valve stem. The method can further include disposing the inner plug within a flow cavity of an outer plug with the valve stem passing slidably through a stem hole of the outer plug of the plug assembly. The method can further include fixing an inner seat ring at an opening of the flow cavity for form a plug subassembly, the inner plug configured to sealingly engage the inner seat ring. The method can further include fixing an outer seat ring to a first opening of a cage, the outer seat ring configured to sealingly engage the outer plug. The method can further include inserting the plug subassembly into a second opening of the cage to form the plug assembly.

### BRIEF DESCRIPTION OF THE DRAWINGS

FIG. 1 is a cross-sectional view of a plug assembly for a valve according to an embodiment of the disclosed technology, including inner and outer plugs.

FIG. 2 is a cross-sectional view of a plug assembly according to another embodiment of the disclosed technology, the plug assembly including inner and outer plugs.

FIG. 3 is a cross-sectional view of a plug assembly according to another embodiment of the disclosed technology, the plug assembly including a spring.

FIG. 4 is a cross-sectional view of a plug assembly according to another embodiment of the disclosed technology, the plug assembly including an outer plug with oblique balancing holes.

FIG. 5 is a cross-sectional view of a plug assembly according to another embodiment of the disclosed technology, the plug assembly including outer balancing holes.

FIG. 6 is a cross-sectional view of a plug assembly according to another embodiment of the disclosed technology, the plug assembly including outer balancing holes.

### DETAILED DESCRIPTION

The concepts disclosed in this discussion are described and illustrated with reference to exemplary arrangements. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

While the flow control assemblies disclosed herein may be embodied in many different forms, several specific embodiments are discussed herein with the understanding that the embodiments described in the present disclosure are to be considered only exemplifications of the principles described herein, and the disclosed technology is not intended to be limited to the examples illustrated.

As briefly discussed above, flow control devices can be used to decrease or otherwise control flow rate or pressure of a fluid flowing from a fluid source toward a downstream application. Certain systems and vessels require control systems or protection to avoid over-pressurization. Flow control devices, such as sliding stem valves, regulators, relief valves, etc., can be used in such systems to reduce or relieve excess fluid pressure. In general, a flow control device can include an inlet, an outlet, and a flow control assembly. The flow control assembly can include a primary control member, such as a disc, plug, or plug assembly, for example, and a secondary control member, such as a cage, to further restrict flow through the flow control device.

Conventional flow control devices can include a rated maximum capacity. In some environments or applications, it can be generally useful to employ a valve with a relatively high maximum flow capacity (e.g., a mass flow rate on the order of 10,000 or 1,000,000 pounds [lbs.]per hour). Thus, a valve having a relatively high rated maximum capacity would be selected. However, in the same environments or applications, it may also be simultaneously useful to employ a valve with a relatively low minimum flow capacity (e.g., on the order of 1% or 10% of the maximum rated capacity). In general, high-capacity valves require relatively large valve/port sizes. Therefore, conventionally, as the valve size grows, the minimum controllable capacity also increases. Thus, a single conventional valve often cannot address both high and low flow rate requirements of a particular environment, which may include widely varying flow conditions.

Embodiments of the present inventive subject matter can address these and other drawbacks of conventional valves and flow control devices. For example, embodiments of the disclosed technology provide a flow control system that can be employed in system that requires flow control for relatively high to relatively low flow rates (an exemplary low flow rate being approximately 1% to 10% of the maximum rated flow rate for the flow control system). The flow control system according to embodiments of the disclosed technology can include a cage, a first plug, and a second plug. Or, from another perspective, a first cage, a second cage, and a plug.

The first, and outer-most cage can surround the first plug. The first plug can form a seal with a seat ring, which can be configured as an outer seat ring, relative to fluid flow through the valve. Further, the first plug can define a flow cavity (e.g., an internal recess). When the second plug is inserted into the flow cavity, the first plug can surround the second plug and can act as a cage to the second plug. The second plug can form a seal with a corresponding seat ring, which can be configured as an inner seat ring, relative to fluid flow through the valve.

In use, the second plug can be lifted off the inner seat ring and can move relative to and within the first plug (e.g., formed as an inner cage) while the first plug remains sealingly engaged with the outer seat ring. This mode of operation can provide flow control at relatively low flow rates. Further, in another mode of operation, the first (outer) plug can be lifted off the outer seat and can move relative to and within the outer cage to provide flow control at relatively high flow rates. In some cases, the inner plug can move independently from the outer plug (e.g., at low flow rates), and when the inner plug reaches a maximum position (e.g., is at a maximum lift height from the inner seat ring), it can urge (directly or indirectly) the outer plug to lift off the corresponding outer seat ring to provide higher flow rates. When the inner plug is at its maximum lift height, both the inner plug and the outer plug can move together to lift the outer plug off the outer seat.

In some examples, the inner plug can be fixed to the stem of the valve so that when the stem moves in an axial direction, the inner plug also moves in the axial direction. Further, there can be a frictional fit between the outer plug and the outer-most cage so that the outer plug can move relative to the outer-most cage only once when the frictional force has been overcome. When the frictional force is overcome, both the inner plug and the outer plug can both move (e.g., away from the outer seat ring) as the stem moves (e.g., away from the outer seat ring). The inner seat ring can be fixed to, or at least relative to, the outer plug. Additionally, the outer seat ring can be fixed to, or at least relative to, the outer-most cage.

During a valve event, fluid can flow from the valve inlet toward the valve outlet across the flow control system. A valve event can be characterized by a variety of flow rates, including steady or variable flow rates. By way of example, a first fluid flow rate during a valve event may be a relatively low flow rate and a second fluid flow rate during a valve event may be a relatively high flow rate, such that the first flow rate is less than the second flow rate. During a valve event with the first flow rate, the outer plug may remain seated on the outer seat ring and act as a cage to the inner plug. The inner plug can correspondingly lift from the inner seat ring and move relative to the outer plug to provide flow control over a range of relatively low flow rates. When the outer plug is seated on the outer seat ring and the inner plug is lifted from the inner seat ring, fluid can flow through radial passageways in the outer plug and also through radial passageways in the outer-most cage. In this regard, at least two sets of radial passageways can provide noise attenuation and overall controlled flow for low flow rates.

During a valve event with the second, higher flow rate, the outer plug can lift off the outer seat ring and the inner plug and the outer plug can move together so that fluid flows from the valve inlet, through the radial passageways in the outer-most cage, and toward the valve outlet. During the second, higher flow rate, the force provided by the stem and inner plug felt by the outer plug may be enough to overcome the frictional fit between the outer plug and the cage so that the outer plug can move with the stem and inner plug and relative to the outer-most cage to provide flow control over a range of relatively high flow rates.

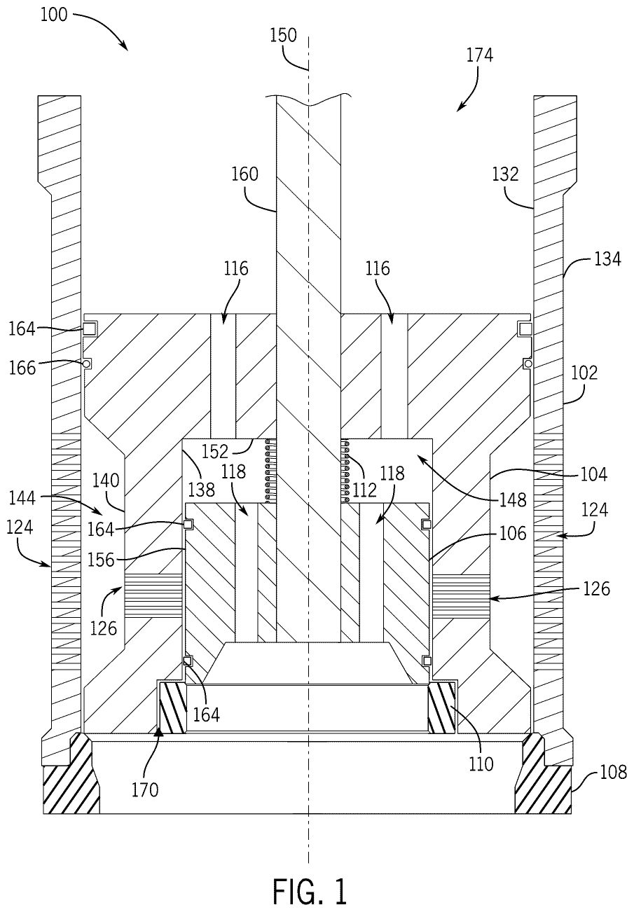

FIGS. 1-6 illustrate exemplary flow control assemblies according to embodiments of the disclosed technology. As also described below, flow control assemblies according to embodiments of the disclosed technology can include variations in form factor (e.g., variations in physical size, component geometry, assembly components, and fluid flow pathways) and can provide flow control for a wide range of flow rates, such as, for example for flow rates between 10% and 100% of a maximum rated flow capacity for a valve, or between 1% and 100% of a maximum rated flow capacity for a valve.

FIG. 1 illustrates an exemplary plug assembly 100 for a valve (not shown, but of configurable as any of various known valve types). The plug assembly 100 includes a plurality of flow control members. For example, the plug assembly 100 can include a cage 102 (e.g., an outer-most cage), a flow control member configured as an outer plug 104, and a flow control member configured as an inner plug 106. However, in some embodiments, the cage 102 can be considered a separate component from the plug assembly 100 (e.g., when the cage 102 is already present and the plug assembly 100 is installed as a retrofit). The plug assembly 100 can further include an outer seat ring 108 and an inner seat ring 110. The outer seat ring 108 can be configured to sealingly engage the outer plug 104 and, correspondingly, the inner seat ring 110 can be configured to sealingly engage the inner plug 106.

The plug assembly 100 can further include a variety of control elements that can be varied (e.g., in geometry and position) or omitted depending on, for example, fluid medium, valve application, rated valve capacity, or noise attenuation requirements. These control elements can include a spring 112, valve stem geometry, axially or obliquely-oriented or inner balancing holes 116 in the outer plug 104, and balancing holes 118 in the inner plug 106. In general, balancing holes facilitate equalizing pressure above, below and in between relative plugs. Furthermore, the cage 102 can include a plurality of radial passageways 124 and the outer plug 104 can include a plurality of radial passageways 126. It should be appreciated that the spacing, geometry (e.g., diameter), or quantity of the radial holes 124, 126 can also vary across embodiments of plug assemblies according to embodiments of the disclosed technology.

With continued reference to FIG. 1, the cage 102 can define a cage body having an internal side wall 132 and an external side wall 134. The internal side wall 132 can face the outer plug 104 and the external side wall 134 can face a valve outlet (not shown in FIG. 1). The outer plug 104 can define a plug body having an internal side wall 138 and an external side wall 140. The internal side wall 138 of the outer plug 104 can face the inner plug 106 and the external side wall 140 of the outer plug 104 can face the internal side wall 132 of the cage 102. In some embodiments, the external side wall 140 of the outer plug 104 can define a geometry that provides an intermediate flow space 144 between the outer plug 104 and the cage 102. The intermediate flow space 144 can include the clearance between the cage 102 and the outer plug 104. Alternatively, as shown in FIG. 1, the intermediate flow space 144 can be greater than a minimum clearance between the cage 102 and the outer plug 104.

The outer plug 104 can further define an inner cavity configured as a flow cavity 148 within the body of the outer plug 104. The flow cavity 148 can be bound in a radial direction (i.e., the direction perpendicular to an axis 150 of the plug assembly 100) by the internal side wall 138 of the outer plug 104. The flow cavity 148 can be bound in an axial direction (i.e., the direction parallel to the axis 150) by a flow cavity stop 152 at one axial end of the flow cavity 148 and by the inner seat ring 108 at the other axial end of the flow cavity 148. In some embodiments, the flow cavity stop 152 can be configured as an internal and upper surface of the outer plug 104 within the flow cavity 148.

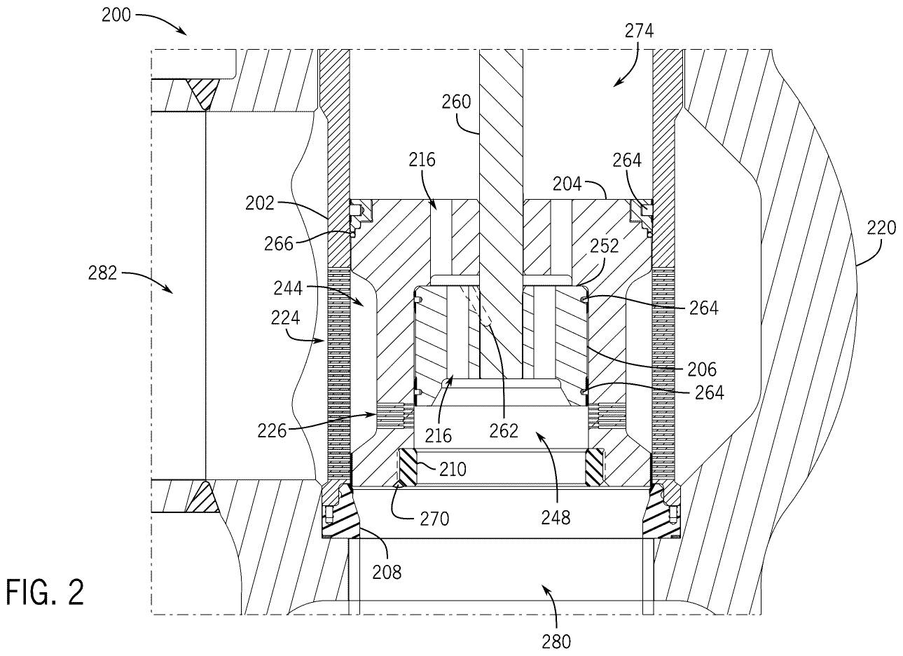

The inner plug 106 can define a plug body having an external side wall 156 that faces the internal side wall 138 of the outer plug 104. Each of the outer plug 104 and the inner plug 106 can be concentric with the cage 102. In use, the inner plug 106 is disposed within the flow cavity 148 of the outer plug 104. The inner plug 106 is configured to move between the inner seat ring 110 and the flow cavity stop 152. The inner plug 106 can be fixed to a valve stem 160 of the valve (not shown in FIG. 1). In some embodiments, the inner plug 106 may be axially fixed to the valve stem 160 via, for example, threads. Further, in some embodiments, the inner plug 106 may be additionally or alternatively radially fixed to the valve stem 160 via, for example, a stem pin (e.g., see stem pin 262 of FIG. 2).

The plug assembly 100 can further include one or more piston rings 164. In general, piston rings can facilitate relative sliding between two bodies and can reduce or prevent fluid flow along clearance regions between bodies. As shown in FIG. 1, the plug assembly 100 can include piston rings 164 between the inner plug 106 and the outer plug 104 within the flow cavity 148. These piston rings 164 can assist the relative sliding of the inner plug 106 and the outer plug 104. Furthermore, the plug assembly 100 can include a piston ring 164 between the outer plug 104 and the cage 102. Likewise, this piston ring 164 can assist in the relative sliding of the outer plug 104 and the cage 102.

With continued reference to FIG. 1, the plug assembly 100 can further include a seal 166. The seal 166 can be configured as a C-seal, or other gasket that provides an interference between the outer plug 104 and the cage 102. The interference provided by the seal 166 can form a frictional hold or force between the outer plug 104 and the cage 102 such that the outer plug 104 cannot slide relative to the cage 102 until an external force (e.g., from the inner plug 106) overcomes the frictional force provided by the seal 166.

In general, the outer plug 104 is configured to slide relative to the cage 102 during a valve event with a relatively high fluid flow rate. In contrast, the outer plug 104 is configured to remain stationary, via the frictional force provided by the seal 166, relative to the cage 102 during a valve event with a relatively low fluid flow rate. During the valve event with the relatively low fluid flow rate, the inner plug 106 can lift from the inner seat ring 110 and fluid can flow through the radial passageways 126 of the outer plug 104 and the radial passageways 124 of the cage 102. In this scenario, the outer plug 104 acts as a cage to the inner plug 106, and the cage 102 can act as a secondary, outer-most cage that can provide further flow control and noise attenuation.

As shown in FIG. 1, the inner seat ring 110 can be fixed relative to the outer plug 104. And in particular, the inner seat ring 110 can be fixed directly to the outer plug 104. In some embodiments, the inner seat ring 110 can be removably fixed (e.g., coupled) to the outer plug 104 so that the inner seat ring 110 can be removed or replaced from the plug assembly 100 during an assembly or maintenance process. In this regard, the inner seat ring 110 can be welded (e.g., tack welded) to the outer plug 104 at one or more weld locations 170. In other embodiments, the inner seat ring 110 can be additionally or alternatively affixed to the outer seat ring 108 via one or more of pins, clips, threads, crimps, etc. Similar to the fixed relationship between the inner seat ring 110 and the outer plug 104, the outer seat ring 108 can be fixed relative to the cage 102.

As briefly described above, the plug assembly 100 is configured accommodate a wide range of fluid flow rates. In use, when the plug assembly 100 is accommodating a first (relatively low) flow rate, the inner plug 106 can lift from the inner seat ring 110 and move upwards (relative to the orientation illustrated in FIG. 1) in the axial direction within the flow cavity 148 of the outer plug 104. In some embodiments, as the inner plug 106 is lifted from the inner seat ring 110 (e.g., by the valve stem 160), a spring such as the spring 112 can be compressed between the inner plug 106 and the flow cavity stop 152. If the pressure force exerted on the flow cavity stop 152 is less than the friction forced between the outer plug 104 and the cage 102 provided by the seal 166, then the outer plug 104 remains stationary (e.g., relative to the cage 102) and in sealing engagement with the outer seat ring 108.

In a second exemplary use condition, when the plug assembly 100 is accommodating a second (relatively high) flow rate, the inner plug 106 can lift from the inner seat ring 110 and move upwards in the axial direction within the flow cavity 148. The inner plug 106 can exert a force on the outer plug 104 (e.g., at the flow cavity stop 152) which, if greater than the frictional force provided by the seal 166, will cause the outer plug 104 to lift from the outer seat ring 108. In the illustrated example of FIG. 1, the spring 112 is in series with the inner plug 106 to apply a lifting force on the outer plug 104 at the flow cavity stop 152. However, in other embodiments (see, for example, FIG. 2), the inner plug 106 can directly engage the flow cavity stop 152 of the outer plug 104.

As briefly described above, the outer plug 104 and the inner plug 106 can optionally include balancing holes, such as the inner balancing holes 116 or the balancing holes 118. In general, balancing holes can be passageways that extend through a body (e.g., a plug) that can allow fluid pressure to equalize on both sides of the body. Balancing holes can generally help minimize forces acting on the plug that would have to be overcome by an actuator. In use, an actuator can actuate the valve stem 160 to provide flow control through the plug assembly 100. The incorporation of one or more balancing holes can help reduce the force required to stroke the actuator and open and close the valve.

As shown in FIG. 1, the inner balancing holes 116 of the outer plug 104 provide a passageway through the body of the outer plug 104 to fluidically couple the flow cavity 148 and the stem space 174. As shown, the inner balancing holes 116 generally extend in the axial direction, however, other orientations are possible. Furthermore, the balancing holes 118 of the inner plug 106 provide a passageway through the body of the inner plug 106 to fluidically couple the flow cavity 148 with an inlet of the valve (not shown in FIG. 1). Similar to the inner balancing holes 116, the balancing holes 118 generally extend in the axial direction, however, other orientations are possible.

As indicated above, the plug assembly 100 can be employed in a valve having an actuator. The actuator can include, or at least be in communication with, a controller to control the actuator. The actuator can actuate the valve stem 160 and provide flow control through the valve. By way of example, if the controller signals the actuator to allow a first flow rate (e.g., a relatively low flow rate) through the valve, then the valve stem 160 can be moved axially upward a first distance, which can lift the inner plug 106 from the inner seat ring 110 and provide the first flow rate through the plug assembly 100. To further the example, if the controller signals the actuator to allow a second flow rate (e.g., a relatively high flow rate) through the valve, then the valve stem 160 can be moved axially upward a second distance. This movement can lift the inner plug 106 from the inner seat ring 110 and, via the inner plug 106, lift the outer plug 104 from the outer seat ring 108 to provide the second flow rate through the plug assembly 100. The upward force provided by the stem 160 (via the inner plug 106) in the second exemplary flow rate scenario is greater than the frictional force provided by the seal 166, which allows the outer plug 104 to move relative to the cage 102.

FIGS. 2-6 illustrate additional examples of plug assemblies according to embodiments of the disclosed technology. In general, similar reference numbers will be used to describe the following examples for similar components described in the plug assembly 100, where applicable. For example, the plug assembly 200 of FIG. 2 can include a cage 202, an outer plug 204, and an inner plug 206 that are similar to the corresponding cage 102, outer plug 104, and inner plug 106 of the plug assembly 100 of FIG. 1. It should be appreciated that the control, relative movement, and operating principles for the following examples are substantially similar to those discussed above with reference to FIG. 1, unless indicated otherwise. Further, components, geometries, and orientations of one or more examples described herein can be adapted to be additionally or alternatively included into these or other plug assemblies, including with respect to particular plug or cage geometries, balancing configurations, biasing, fixed, or frictional engagements, and so on.

With reference to FIG. 2, the plug assembly 200 includes the cage 202, the outer plug 204, and the inner plug 206. The outer plug 204 is configured to sealingly engage an outer seat ring 208 and the inner plug 206 is configured to sealingly engage an inner seat ring 210. The cage 202 can be fixed relative to a valve body 220. Furthermore, the inner seat ring 210 can be fixed relative to the outer plug 204. The inner seat ring 210 can be fixed to the outer plug 204 via a weld location 270 or other fixation. The inner plug 206 can be disposed within a flow cavity 248 of the outer plug 204. Furthermore, the inner plug 206 can be fixed to a valve stem 260 of the valve, the valve stem 260 extending through a stem space 274 defined by the valve body 220. In some embodiments, the inner plug 206 can be threadably secured to the valve stem 260. Further, in the illustrated embodiment, the plug assembly 200 can include a stem pin 262 to rotationally fix the inner plug 206 to the valve stem 260.

The plug assembly 200 can further include piston rings 264 to facilitate sliding between the inner plug 206 and the outer plug 204, and between the outer plug 204 and the cage 202 when a certain force threshold is exceeded. A seal 266 disposed between the outer plug 204 and the cage 202 and provide a frictional fit between the outer plug 204 and the cage 202. Thus, a particular force threshold that allows the outer plug 204 to move relative to the cage 202 may be defined by the frictional force provided by the seal 266 (e.g., alone or in combination with the piston rings 264, and any other clearance fittings between the outer plug 204 and the cage 202). In this regard, the outer plug 204 can remain stationary relative to the cage 202 until the force felt by the outer plug 204 from the inner plug 206 overcomes the frictional force between the outer plug 204 and the cage 202.

In some cases, a force to overcome a frictionally-defined threshold can be applied by an inner plug indirectly, including as discussed above via a spring, or other intermediary element between the inner plug and the outer plug. As another example, an inner plug can directly engage an outer plug to overcome the frictionally-defined threshold. For instance, during use of the plug assembly 200, the inner plug 206 can engage a flow cavity stop 252 of the outer plug 204 to lift the outer plug 204 from the outer seat ring 208. In the illustrated example of FIG. 2, the inner plug 206 is in an open position and lifted from the inner seat ring 210. In this orientation, fluid could flow from a valve inlet 280, through radial passageways 226 in the outer plug 204, through radial passageways 224 in the cage 202, and toward a valve outlet 282. This orientation can correspond to a relatively low flow rate through the valve.

With continued reference to FIG. 2, the radial passageways 226 in the illustrated embodiment can include varied diameters in the radial direction. For example, the diameter of each passageway 226 has a stepped increase such that the diameter increases as the passageway extends radially outward. This variation in diameter can provide additional valve noise attenuation and can facilitate the manufacturing of the outer plug 204. As also shown in FIG. 2, the radial passageways can fluidically couple the flow cavity 248 and an intermediate flow space 244. Furthermore, the balancing holes of the embodiment shown in FIG. 2 include inner balancing holes 216 that fluidically couple the stem space 274 and the flow cavity 248 and balancing holes 218 that fluidically couple the flow cavity 248 and the valve inlet 280.

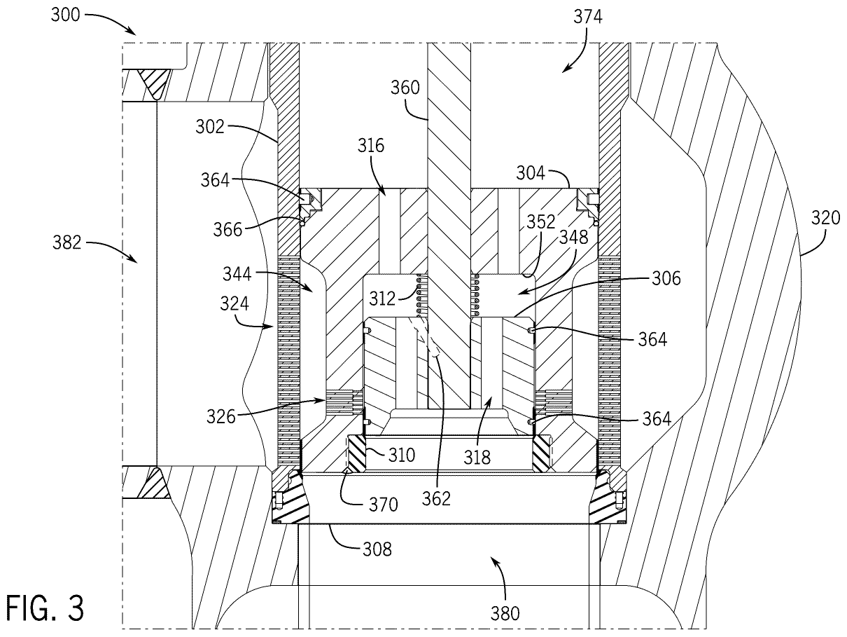

FIG. 3 illustrates a plug assembly 300 according to another embodiment of the disclosed technology. The plug assembly 300, similar to the plug assemblies described above, can include a cage 302, an outer plug 304, and an inner plug 306. The outer plug 304 can be configured to sealingly engage an outer seat ring 308 and the inner plug 306 can be configured to sealingly engage an inner seat ring 310. The cage 302 can be fixed relative to a valve body 320. Furthermore, the inner seat ring 310 can be fixed relative to the outer plug 304. The inner seat ring 310 can be fixed to the outer plug 304 via a weld location 370 or other fixation. The inner plug 306 can be disposed within a flow cavity 348 of the outer plug 304. Furthermore, the inner plug 306 can be fixed to a valve stem 360 of the valve, the valve stem 360 extending through a stem space 374 defined by the valve body 320. Further, in the illustrated embodiment, the plug assembly 300 can include a stem pin 362 to rotationally fix the inner plug 306 to the valve stem 360.

The plug assembly 300 can further include piston rings 364 to facilitate sliding between the inner plug 306 and the outer plug 304, and between the outer plug 304 and the cage 302 when a certain force threshold is exceeded. A seal 366 disposed between the outer plug 304 and the cage 302 and provide a frictional fit between the outer plug 304 and the cage 302. Thus, a particular force threshold that allows the outer plug 304 to move relative to the cage 302 may be defined by the frictional force provided by the seal 366 (e.g., alone or in combination with the piston rings 364, and any other clearance fittings between the outer plug 304 and the cage 302). In this regard, the outer plug 304 can remain stationary relative to the cage 302 until the force felt by the outer plug 304 from the inner plug 306 overcomes the frictional force between the outer plug 304 and the cage 302.

In the illustrated example of FIG. 3, the valve is in a closed position, and each of the plugs 304, 306 are seated on their respective seat rings 308, 310. In this orientation, fluid is prevented from flowing from a valve inlet 380, through radial passageways 326 in the outer plug 304, through radial passageways 324 in the cage 302, and toward a valve outlet 382. Like the plug assemblies described above, the plug assembly 300 can control a wide variety of flow rates, including relatively low flow rates and relatively high flow rates. For example, during some relatively low flow rates, the inner plug 306 may be lifted from the inner seat ring 310 while the outer plug 304 remains seated on the outer seat ring 308. And during relatively high flow rates, each of the plugs 304, 306 can be lifted from their respective seat rings 308, 310.

For example, in use, if the valve stem 360 moves the inner plug 306 upward, and if the upward force exerted on the outer plug 304 by the inner plug 306 exceeds the static force formed by the interference fit between the outer plug 304 and the cage 302, then the plugs 304, 306 can move together so that the outer plug 304 lifts off the outer seat ring 308.

With continued reference to FIG. 3, the plug assembly 300 can include a spring 312 (e.g., a coil spring as shown, or other known types of spring for biased axial movement). In some embodiments, the spring 312 can help the valve reach a maximum flow rate capacity or provide more precise control by biasing the inner plug 306 away from the outer plug 304. For example, in one flow scenario, as the inner plug 306 lifts from its inner seat ring 308, the spring 312 can begin to compress and correspondingly begin to apply a force on the flow cavity stop 352 so that the outer plug 304 can begin to lift from the outer seat ring 308 before the inner plug 306 reaches a maximum lift height. This arrangement can thus provide more precise or steady flow control and a more gradual application of lift force to the outer plug 304 than in the examples of FIGS. 1 and 2.

FIG. 3 also illustrates another exemplary embodiment of a balancing hole arrangement. In particular, the inner balancing holes 316 fluidically couple the stem space 374 and the flow cavity 348, and the balancing holes 318 fluidically couple the flow cavity 348 and the valve inlet 380. In other embodiments, additional or alternative balancing holes can fluidically couple an intermediate flow space 344 to one or more of the stem space 374 or valve inlet 380 (see, for example, FIG. 1).

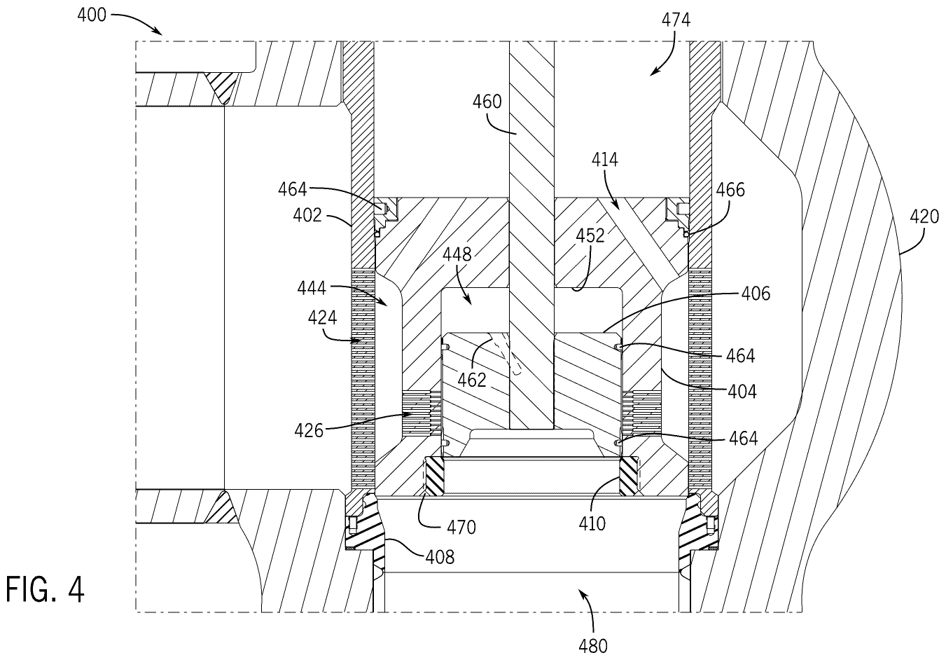

FIG. 4 illustrates a plug assembly 400 according to another embodiment of the disclosed technology. The plug assembly 400, similar to the plug assemblies described above, can include a cage 402, an outer plug 404, and an inner plug 406. The outer plug 404 can be configured to sealingly engage an outer seat ring 408 and the inner plug 406 can be configured to sealingly engage an inner seat ring 410. The outer plug 404 can include radial passageways 426 and the cage 402 can include radial passageways 424 to control flow. The cage 402 can be fixed relative to a valve body 420. Furthermore, the inner seat ring 410 can be fixed relative to the outer plug 404. The inner seat ring 410 can be fixed to the outer plug 404 via a weld location 470 or other fixation. The inner plug 406 can be disposed within a flow cavity 448 of the outer plug 404, the cavity 448 including a flow cavity stop 452. Furthermore, the inner plug 406 can be fixed to a valve stem 460 of the valve, the valve stem 460 extending through a stem space 474 defined by the valve body 420. Further, in the illustrated embodiment, the plug assembly 400 can include a stem pin 462 to rotationally fix the inner plug 406 to the valve stem 460.

The plug assembly 400 can further include piston rings 464 to facilitate sliding between the inner plug 406 and the outer plug 404, and between the outer plug 404 and the cage 402 when a certain force threshold is exceeded. A seal 466 disposed between the outer plug 404 and the cage 402 and provide a frictional fit between the outer plug 404 and the cage 406. Thus, a particular force threshold that allows the outer plug 404 to move relative to the cage 402 may be defined by the frictional force provided by the seal 466 (e.g., alone or in combination with the piston rings 464, and any other clearance fittings between the outer plug 404 and the cage 402). In this regard, the outer plug 404 can remain stationary relative to the cage 402 until the force felt by the outer plug 404 from the inner plug 406 overcomes the frictional force between the outer plug 404 and the cage 402.

FIG. 4 also illustrates another exemplary embodiment of a balancing hole arrangement. In particular, outer balancing holes 414 can fluidically couple the stem space 474 and an intermediate flow space 444 radially positioned between the cage 402 and the outer plug 404. In other embodiments, additional or alternative balancing holes can fluidically couple one or more of the stem space 474, the flow cavity 448, and the valve outlet 480. The outer balancing holes 414 can provide a balancing force system for the outer plug 404 during a higher capacity flow rate in which the outer plug 404 is lifted off the outer seat ring 408. This can reduce the actuator force required to close the entire valve and also maintain relatively precise actuation control of the inner plug 406.

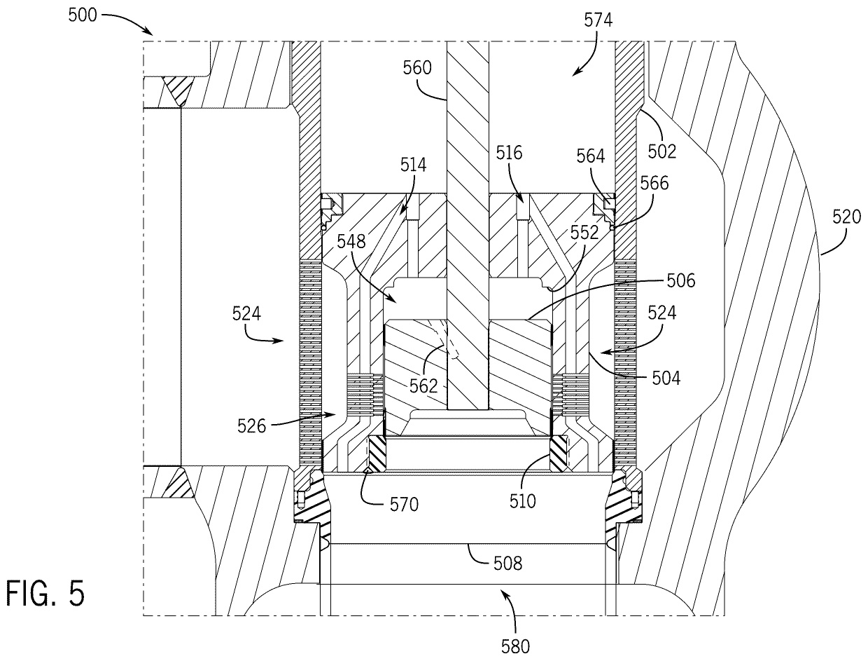

FIG. 5 illustrates a plug assembly 500 according to another embodiment of the disclosed technology. The plug assembly 500, similar to the plug assemblies described above, can include a cage 502, an outer plug 504, and an inner plug 506. The outer plug 504 can be configured to sealingly engage an outer seat ring 508 and the inner plug 506 can be configured to sealingly engage an inner seat ring 510. The outer plug 504 can include radial passageways 526 and the cage 502 can include radial passageways 524 to control flow. The cage 502 can be fixed relative to a valve body 520. Furthermore, the inner seat ring 510 can be fixed relative to the outer plug 504. The inner seat ring 510 can be fixed to the outer plug 504 via a weld location 570 or other fixation. The inner plug 506 can be disposed within a flow cavity 548 of the outer plug 504, the cavity 548 including a flow cavity stop 552. Furthermore, the inner plug 506 can be fixed to a valve stem 560 of the valve, the valve stem 560 extending through a stem space 574 defined by the valve body 520. Further, in the illustrated embodiment, the plug assembly 500 can include a stem pin 562 to rotationally fix the inner plug 506 to the valve stem 560.

The plug assembly 500 can further include piston rings 564 to facilitate sliding between the inner plug 506 and the outer plug 504, and between the outer plug 504 and the cage 502 when a certain force threshold is exceeded. A seal 566 disposed between the outer plug 504 and the cage 502 and provide a frictional fit between the outer plug 504 and the cage 506. Thus, a particular force threshold that allows the outer plug 504 to move relative to the cage 502 may be define by the frictional force provided by the seal 566 (e.g., alone or in combination with the piston rings 564, and any other clearance fittings between the outer plug 504 and the cage 502). In this regard, the outer plug 504 can remain stationary relative to the cage 502 until the axial force felt by the outer plug 504 from the inner plug 506 overcomes the frictional force between the outer plug 504 and the cage 502.

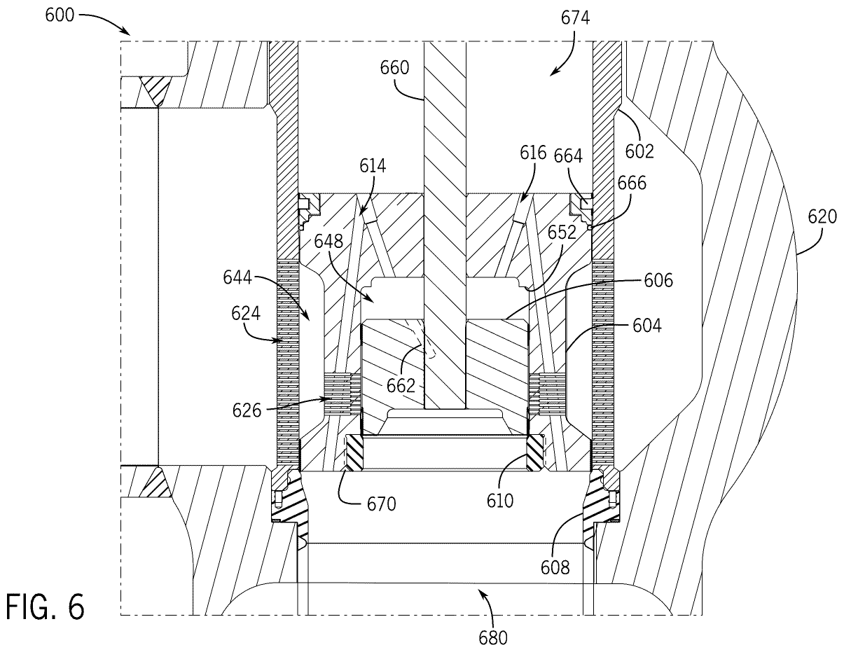

FIG. 5 also illustrates another exemplary embodiment of a balancing hole arrangement. In particular, outer balancing holes 514 can fluidically couple the stem space 574 and the valve inlet 580, and inner balancing holes 516 can fluidically couple the stem space 574 and the flow cavity 558. In the embodiment shown, the inner plug 506 may be formed from an additive manufacturing process (e.g., 3D printing). The outer balancing holes 514 may be formed during a printing process since they have a bent geometry in the axial direction. In contrast, outer balancing holes without a bent geometry may be drilled as a secondary process after the inner plug is already formed (see, for example, outer balancing holes 614 of FIG. 6). In other embodiments, additional or alternative balancing holes can fluidically couple one or more of an intermediate flow space 544, the stem space 574, the flow cavity 548, and the valve inlet 580.

FIG. 6 illustrates a plug assembly 600 according to another embodiment of the disclosed technology. The plug assembly 600, similar to the plug assemblies described above, can include a cage 602, an outer plug 604, and an inner plug 606. The outer plug 604 can be configured to engage an outer seat ring 608 and the inner plug 606 can be configured to engage an inner seat ring 610. The outer plug 604 can include radial passageways 626 and the cage 602 can include radial passageways 624 to control flow. The cage 602 can be fixed relative to a valve body 620. Furthermore, the inner seat ring 610 can be fixed relative to the outer plug 606. The inner seat ring 610 can be fixed to the outer plug 606 via a weld location 670 or other fixation. The inner plug 606 can be disposed within a flow cavity 648 of the outer plug 604, the cavity 648 including a flow cavity stop 652. Furthermore, the inner plug 606 can be fixed to a valve stem 660 of the valve, the valve stem 660 extending through a stem space 674 defined by the valve body 620. Further, in the illustrated embodiment, the plug assembly 600 can include a stem pin 662 to rotationally fix the inner plug 606 to the valve stem 660.

The plug assembly 600 can further include piston rings 664 to facilitate sliding between the inner plug 606 and the outer plug 604, and between the outer plug 604 and the cage 602 when a certain force threshold is exceeded. A seal 666 disposed between the outer plug 604 and the cage 602 and provide a frictional fit between the outer plug 604 and the cage 606. Thus, a particular force threshold that allows the outer plug 604 to move relative to the cage 602 may be defined by the frictional force provided by the seal 666 (e.g., alone or in combination with the piston rings 664, and any other clearance fittings between the outer plug 604 and the cage 602). In this regard, the outer plug 604 can remain stationary relative to the cage 602 until the axial force felt by the outer plug 604 from the inner plug 606 overcomes the frictional force between the outer plug 604 and the cage 602.

FIG. 6 also illustrates another exemplary embodiment of a balancing hole arrangement. In particular, outer balancing holes 614 can fluidically couple the stem space 674 and the valve inlet 680, and inner balancing holes 616 can fluidically couple the stem space 674 and the flow cavity 658. In other embodiments, additional or alternative balancing holes can fluidically couple one or more of an intermediate flow space 644 (see, e.g., FIG. 1), the stem space 674, the flow cavity 648, and the valve inlet 680.

Each of the plug assemblies described above can be used in a valve to control a variety of flow rates (e.g., over a variety of different low and high flow rate ranges). The plug assembly configurations shown in FIGS. 1-6 may be by way of example and can include other arrangements not necessarily shown in a single embodiment (e.g., substitution or combination of any number of components from two or more embodiments). Further, each of the plug assemblies can be configured to be incorporated into a new valve, or as a retrofit assembly into an existing valve.

During an assembly process of a plug assembly according to embodiments of the disclosed technology, an inner plug can be fixed to a valve stem and seated within a flow cavity of an outer plug. An inner seat ring can be affixed to an axial end of the outer plug, opposite the valve stem to form a plug subassembly. The plug subassembly can then be inserted into a valve, and more specifically, inserted into a cage fixed relative to the valve body. The outer plug can be configured to form a seal with an outer seat ring fixed relative to the cage, and the inner plug can be configured to form a seal with the inner seat ring.

Thus, examples of the disclosed technology can provide an improvement over conventional flow control assemblies. The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the disclosed technology, of the utilized features and implemented capabilities of such device or system.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Also as used herein, unless otherwise limited or defined, “configured to” indicates that a component, system, or module is particularly adapted for the associated functionality. Thus, for example, a ZZ configured to YY is specifically adapted to YY, as opposed to merely being generally capable of doing so.

Although the presently disclosed technology has been described with reference to preferred examples, workers skilled in the art will recognize that changes may be made in form and detail to the disclosed examples without departing from the spirit and scope of the concepts discussed herein.

1. A flow control assembly for a valve having a valve inlet, the flow control assembly comprising:
a cage;
an outer seat ring fixed relative to the cage;
an outer plug in fluid communication with the valve inlet, the outer plug being movable in an axial direction relative to the cage to sealingly engage the outer seat ring;
an inner seat ring fixed relative to the outer plug; and
an inner plug in fluid communication with the valve inlet, the inner plug being movable in the axial direction relative to the outer plug to sealingly engage the inner seat ring,
in a first configuration to control flow over a first range of flow rates, the inner plug being disengaged from the inner seat ring and the outer plug being sealingly engaged with the outer seat ring, and
wherein in a second configuration to control flow over a second range of flow rates, the inner plug being disengaged from the inner seat ring and the outer plug being disengaged from the outer seat ring.

2. The flow control assembly of claim 1, wherein the outer plug defines an inner cavity and the inner plug is moveable in the axial direction within the inner cavity.

3. The flow control assembly of claim 2, wherein the inner cavity is in fluid communication with the valve inlet via one or more balancing holes that extend through the inner plug.

4. The flow control assembly of claim 2, wherein a spring is disposed within the inner cavity, between the outer plug and the inner plug relative to the axial direction.

5. The flow control assembly of claim 1, wherein the outer plug frictionally engages the cage so that:
over the first range of flow rates, the outer plug is maintained in sealing engagement with the outer seat ring, and
over the second range of flow rates, the inner plug applies axial force to the outer plug to overcome the frictional engagement between the outer plug and the cage, so that the outer plug is disengaged from the outer seat ring.

6. The flow control assembly of claim 1, wherein the inner plug is fixed to a stem of the valve and the outer plug is not fixed to the stem of the valve, relative to axial movement along the stem.

7. The flow control assembly of claim 1, wherein the inner seat ring is fixed to the outer plug via one or more tack welds.

8. A flow control assembly for a valve, the valve having a valve body and a valve stem, the valve body defining a valve inlet and a valve outlet, the flow control assembly comprising:
a first valve seat;
a first flow control member defining a flow cavity, the first flow control member being movable relative to the first valve seat in an axial direction to sealingly engage the first valve seat;
a second valve seat supported by the first flow control member; and
a second flow control member disposed within the flow cavity and affixed to the valve stem, the second flow control member being moveable in the axial direction relative to the valve body and the first flow control member to sealingly engage the second valve seat.

9. The flow control assembly of claim 8, further comprising:
a cage that circumferentially surrounds the first and second flow control members,
wherein the first valve seat is fixed relative to the cage.

10. The flow control assembly of claim 9, further comprising:
a seal disposed between the cage and the first flow control member to provide a friction force between the cage and the first flow control member,
wherein during a valve release event, the second flow control member is moved axially out of engagement with the second valve seat and the first flow control member remains engaged with the first valve seat until a pressure force threshold on first flow control member is met.

11. The flow control assembly of claim 9, wherein a first set of radial passageways in the first flow control member and a second set of radial passageways in the cage are oriented to permit fluid to flow therethrough when the first flow control member disengaged from the first valve seat.

12. The flow control assembly of claim 8, further comprising:
a spring member disposed within the flow cavity and positioned in series with the second flow control member,
wherein the spring member biases the second flow control member toward the second valve seat.

13. The flow control assembly of claim 8, wherein the first flow control member includes one or more passageways that extend in the axial direction, and
wherein the one or more passageways fluidically couple the flow cavity with a stem space of the valve, the valve stem extending through the stem space of the valve.

14. The flow control assembly of claim 8, wherein the second flow control member includes one or more passageways that extend in the axial direction, and
wherein the one or more passageways fluidically couple the flow cavity with the valve inlet.

15. The flow control assembly of claim 8, wherein the first flow control member and the second flow control member include a plurality of passageways, and
wherein the plurality of passageways fluidically couple a stem space of the valve with the valve inlet, the valve stem extending through the stem space of the valve.

16. The flow control assembly of claim 8, wherein a clearance is provided between a radial side wall of the second flow control member and a radial side wall of the flow cavity.

17. The flow control assembly of claim 8, wherein the first flow control member includes a plurality of radially extending passageways that fluidically couple the flow cavity with the valve outlet.

18. The flow control assembly of claim 8, wherein the second flow control member is affixed to the valve stem via a threaded connection.

19. A method of assembling a flow control assembly for a valve halving a valve stem, the method comprising:
fixing an inner plug of a plug assembly to the valve stem;
disposing the inner plug within a flow cavity of an outer plug, with the valve stem passing slidably through a stem hole of an outer plug of the plug assembly;
fixing an inner seat at an opening of the flow cavity to form a plug subassembly, the inner plug configured to sealingly engage the inner seat ring;
fixing an outer seat ring to a first opening of a cage, the outer plug configured to sealingly engage the outer plug; and
inserting the plug subassembly into a second opening of the cage to form the plug assembly.

20. The method of claim 19, further comprising:
passing the valve stem through a spring so that the spring is positioned axially between the inner plug and the outer plug, and within the flow cavity.
